(19) United States
(12) Patent Application Publication
(10) Pub. No.: US 2025/0272328 A1
(43) Pub. Date: Aug. 28, 2025

(54) METHOD AND APPARATUS FOR PRESENTING INFORMATION

(71) Applicant: Beijing Zitiao Network Technology Co., Ltd., Beijing (CN)

(72) Inventors: Zesong ZHOU, Beijing (CN); Liyue ZHAO, Beijing (CN)

(21) Appl. No.: 18/859,929

(22) PCT Filed: Apr. 24, 2023
(86) PCT No.: PCT/CN2023/090182

§ 371 Date: Oct. 24, 2024

(30) Foreign Application Priority Data
Apr. 24, 2022 (CN) 202210434583.3

(51) Int. Cl. G06F 16/338; G06F 16/3329; G06F 40/289

(52) U.S. Cl. CPC G06F 16/338; G06F 16/3329; G06F 40/289

(57) ABSTRACT

A method for presenting information is provided. The method comprises: obtaining an entry association corresponding to a target keyword on a client side in response to triggering, by a user, a relationship viewing operation on an entry carrier of the target keyword, wherein the entry association corresponding to the target keyword is configured to present a primary associated keyword associated to the target keyword and a secondary associated keyword associated to the target keyword, and the secondary associated keyword is a keyword associated to the primary associated keyword. After obtaining the entry association corresponding to the target keyword, the client side may further present the entry association of the target keyword.

### CROSS-REFERENCE TO RELATED APPLICATION(S)

The present application claims the priority to Chinese Patent Application No. 202210434583.3 filed with the Chinese Patent Office on Apr. 24, 2022 and entitled “Method and apparatus for presenting information”, which is incorporated herein in its entirety by reference.

### FIELD

The present application relates to the field of computer technology, in particular to a method and apparatus for presenting information.

### BACKGROUND

An entry functions as a container of content. The entry of a keyword may include content associated to the keyword, through which, a user may access content information associated to the keyword.

However, such an entry for the keyword provides too limited content information to satisfy demand of the user generally. In view of that, it is a pressing issue to develop a solution for solving the problem.

### SUMMARY

In order to solve the technical problem that how to provide a user with more content associated to a keyword and satisfy demand of the user as much as possible, the present application provides a method and apparatus for presenting information.

In a first aspect, embodiments of the present application provide a method for presenting information. The method comprises:
obtaining an entry association corresponding to a target keyword in response to triggering, by a user, a relationship viewing operation on an entry carrier of the target keyword, wherein the entry association corresponding to the target keyword is configured to present a primary associated keyword associated to the target keyword and a secondary associated keyword associated to the target keyword, the secondary associated keyword is a keyword associated to the primary associated keyword, and the entry carrier is configured to carry content information of the target keyword; and
presenting the entry association corresponding to the target keyword.

Optionally, the entry carrier of the target keyword is presented in response to triggering, by the user, a preset operation on the target keyword.

Optionally, the method further comprises:
highlighting the target keyword in response to detecting the target keyword in target content.

Optionally, the target content comprises: a message of an instant messaging session, and/or content of a cloud document.

Optionally, the entry carrier of the target keyword is presented on an entry viewing page.

Optionally, the entry carrier of the target keyword is presented in a first area of the entry viewing page, and the method further comprises:
presenting, in a second area, complete content carried by the entry carrier in response to triggering, by the user, an entry viewing operation on the entry carrier of the target keyword, wherein the second area is obtained by expanding the first area, and the second area comprises the first area.

Optionally, the entry carrier of the target keyword is presented on an entry search result page.

Optionally, the entry search result page further comprises an entry carrier of the primary associated keyword associated to the target keyword.

Optionally, the entry association is an entry relationship graph.

Optionally, the method further comprises:
presenting an entry carrier corresponding to a first keyword presented in the entry relationship graph in response to triggering, by the user, a selection operation on the first keyword.

Optionally, the selection operation comprises a click operation, and/or a hover operation.

Optionally, the method further comprises:
presenting an entry relationship graph corresponding to the first keyword, wherein the entry relationship graph corresponding to the first keyword is configured to present a primary associated keyword associated to the first keyword and a secondary associated keyword associated to the first keyword.

Optionally, the method further comprises:
adjusting a presentation of the first keyword to a center of a page where the first keyword is located.

Optionally, the first keyword is presented at a first position in a page where the first keyword is located, and the first position is a position where the first keyword is located in a case that the page presents the entry relationship graph of the target keyword.

Optionally, in a case that the entry relationship graph corresponding to the first keyword is presented, a different association between the entry relationship graph corresponding to the target keyword and the entry relationship graph corresponding to the first keyword is not presented.

Optionally, a number of primary associated keywords associated to the target keyword presented in the entry relationship graph of the target keyword is M, M is an integer greater than 1, and the M primary associated keywords are distributed evenly on a circle with the target keyword as a center.

Optionally, a number of primary associated keywords associated to the target keyword presented in the entry relationship graph of the target keyword is M, M is an integer greater than 1, the M primary associated keywords comprise a first primary associated keyword, the secondary associated keyword associated to the target keyword comprises A secondary associated keywords associated to the first primary associated keyword, and the A secondary associated keywords are distributed on a circle with the first primary associated keyword as a center.

Optionally, a number of primary associated keywords associated to the target keyword presented in the entry relationship graph of the target keyword is M, M is an integer greater than 1, and the M primary associated keywords comprise a second primary associated keyword and a third primary associated keyword, wherein in a case that the second primary associated keyword and the third primary associated keyword are associated, a distance between the second primary associated keyword and the third primary associated keyword is shorter than or equal to a distance between the second primary associated keyword and a further primary associated keyword, and wherein the further primary associated keyword is a primary associated keyword among the M primary associated keywords other than the second primary associated keyword and the third primary associated keyword.

Optionally, a number of primary associated keywords associated to the target keyword presented in the entry relationship graph of the target keyword is M, a number of secondary associated keywords associated to the target keyword presented in the entry relationship graph of the target keyword is N, M and N are integers greater than 1, the N secondary associated keywords comprise a first secondary associated keyword, and the M primary associated keywords comprise a fourth primary associated keyword and a fifth primary associated keyword, wherein in a case that the fourth primary associated keyword and the fifth primary associated keyword are associated to the first secondary associated keyword, a distance between the fourth primary associated keyword and the fifth primary associated keyword is shorter than or equal to a distance between the fourth primary associated keyword and a further primary associated keyword, and wherein the further primary associated keyword is a primary associated keyword among the M primary associated keywords other than the fourth primary associated keyword and the fifth primary associated keyword.

Optionally, the method further comprises:
presenting an association between the target keyword and the primary associated keyword; and
presenting an association between the primary associated keyword and the secondary associated keyword.

Optionally, presenting the association between the target keyword and the primary associated keyword comprises:
presenting a connection line and/or relationship attribute description information between the target keyword and the primary associated keyword;
presenting the association between the primary associated keyword and the secondary associated keyword comprises:
presenting a connection line and/or relationship attribute description information between the primary associated keyword and the secondary associated keyword.

Optionally, the entry relationship graph comprises a second keyword, and a character identification of a character associated to the second keyword is presented as an attribute of the second keyword in the entry relationship graph, and the method further comprises at least one of:
presenting at least one entry associated to the character in response to a trigger operation on the character identification; and
presenting at least one entry associated to the second keyword in response to a trigger operation on the second keyword.

Optionally, the method further comprises:
adding an entry into the entry relationship graph in response to triggering an entry adding operation on the entry relationship graph.

Optionally, the entry relationship graph comprises a third keyword, and the method further comprises:
obtaining description information edited for the third keyword and adding the description information for the third keyword, in response to triggering an editing operation on the third keyword.

Optionally, in response to triggering, by the user, the relationship viewing operation on the entry carrier of the target keyword comprises:
in response to triggering, by the user, a search operation on the target keyword in an interface of the entry relationship graph. In a second aspect, the embodiments of the present application provide an apparatus for presenting information. The apparatus comprises:
an obtaining unit, configured to obtain an entry association corresponding to a target keyword in response to triggering, by a user, a relationship viewing operation on an entry carrier of the target keyword, wherein the entry association corresponding to the target keyword is configured to present a primary associated keyword associated to the target keyword and a secondary associated keyword associated to the target keyword, the secondary associated keyword is a keyword associated to the primary associated keyword, and the entry carrier is configured to carry content information of the target keyword; and
a first presenting unit, configured to present the entry association corresponding to the target keyword.

Optionally, the entry carrier of the target keyword is presented in response to triggering, by the user, a preset operation on the target keyword.

Optionally, the apparatus further comprises:
a display unit, configured to highlight the target keyword in response to detecting the target keyword in target content.

Optionally, the target content comprises: a message of an instant messaging session, and/or content of a cloud document.

Optionally, the entry carrier of the target keyword is presented on an entry viewing page.

Optionally, the entry carrier of the target keyword is presented in a first area of the entry viewing page, and the apparatus further comprises:
a second presenting unit, configured to present, in a second area, complete content carried by the entry carrier in response to triggering, by the user, an entry viewing operation on the entry carrier of the target keyword, wherein the second area is obtained by expanding the first area, and the second area comprises the first area.

Optionally, the entry carrier of the target keyword is presented on an entry search result page.

Optionally, the entry search result page further comprises an entry carrier of the primary associated keyword associated to the target keyword.

Optionally, the entry association is an entry relationship graph.

Optionally, the apparatus further comprises:
a third presenting unit, configured to present an entry carrier corresponding to a first keyword presented in the entry relationship graph in response to triggering, by the user, a selection operation on the first keyword.

Optionally, the selection operation comprises a click operation, and/or a hover operation.

Optionally, the apparatus further comprises:
a fourth presenting unit, configured to present an entry relationship graph corresponding to the first keyword, wherein the entry relationship graph corresponding to the first keyword is configured to present a primary associated keyword associated to the first keyword and a secondary associated keyword associated to the first keyword.

Optionally, the apparatus further comprises:
a fifth presenting unit, configured to adjust a presentation of the first keyword to a center of a page where the first keyword is located.

Optionally, the first keyword is presented at a first position in a page where the first keyword is located, and the first position is a position where the first keyword is located in a case that the page presents the entry relationship graph of the target keyword.

Optionally, in a case that the entry relationship graph corresponding to the first keyword is presented, a different association between the entry relationship graph corresponding to the target keyword and the entry relationship graph corresponding to the first keyword is not presented.

Optionally, a number of primary associated keywords associated to the target keyword presented in the entry relationship graph of the target keyword is M, M is an integer greater than 1, and the M primary associated keywords are distributed evenly on a circle with the target keyword as a center.

Optionally, a number of primary associated keywords associated to the target keyword presented in the entry relationship graph of the target keyword is M, M is an integer greater than 1, the M primary associated keywords comprise a first primary associated keyword, the secondary associated keyword associated to the target keyword comprises A secondary associated keywords associated to the first primary associated keyword, and the A secondary associated keywords are distributed on a circle with the first primary associated keyword as a center.

Optionally, a number of primary associated keywords associated to the target keyword presented in the entry relationship graph of the target keyword is M, M is an integer greater than 1, and the M primary associated keywords comprise a second primary associated keyword and a third primary associated keyword, wherein in a case that the second primary associated keyword and the third primary associated keyword are associated, a distance between the second primary associated keyword and the third primary associated keyword is shorter than or equal to a distance between the second primary associated keyword and a further primary associated keyword, and wherein the further primary associated keyword is a primary associated keyword among the M primary associated keywords other than the second primary associated keyword and the third primary associated keyword.

Optionally, a number of primary associated keywords associated to the target keyword presented in the entry relationship graph of the target keyword is M, a number of secondary associated keywords associated to the target keyword presented in the entry relationship graph of the target keyword is N, M and N are integers greater than 1, the N secondary associated keywords comprise a first secondary associated keyword, and the M primary associated keywords comprise a fourth primary associated keyword and a fifth primary associated keyword, wherein in a case that the fourth primary associated keyword and the fifth primary associated keyword are associated to the first secondary associated keyword, a distance between the fourth primary associated keyword and the fifth primary associated keyword is shorter than or equal to a distance between the fourth primary associated keyword and a further primary associated keyword, and wherein the further primary associated keyword is a primary associated keyword among the M primary associated keywords other than the fourth primary associated keyword and the fifth primary associated keyword.

Optionally, the apparatus further comprises:
a sixth presenting unit, configured to present an association between the target keyword and the primary associated keyword; and
a seventh presenting unit, configured to present an association between the primary associated keyword and the secondary associated keyword.

Optionally, the sixth presenting unit is configured to:
present a connection line and/or relationship attribute description information between the target keyword and the primary associated keyword.

Optionally, the seventh presenting unit is configured to:
present a connection line and/or relationship attribute description information between the primary associated keyword and the secondary associated keyword.

Optionally, the entry relationship graph comprises a second keyword, and a character identifier of a character associated to the second keyword is presented as an attribute of the second keyword in the entry relationship graph, and the apparatus further comprises an eighth presenting unit and/or a ninth presenting unit.

The eighth presenting unit is configured to present at least one entry associated to the character in response to a trigger operation on the character identification; and
the ninth presenting unit is configured to present at least one entry associated to the second keyword in response to a trigger operation on the second keyword.

Optionally, the apparatus further comprises:
an entry adding unit, configured to add an entry into the entry relationship graph in response to triggering an entry adding operation on the entry relationship graph.

Optionally, the entry relationship graph comprises a third keyword, and the apparatus further comprises:
a processing unit, configured to obtain description information edited for the third keyword and adding the description information for the third keyword, in response to triggering an editing operation on the third keyword.

Optionally, the obtaining unit is configured to obtain an entry association corresponding to the target keyword in response to triggering, by the user, a search operation on the target keyword in an interface of the entry relationship graph.

In a third aspect, the embodiments of the present application provide a device. The device comprises: a processor and a memory,
wherein the processor is configured to execute instructions stored in the memory, causing the device to execute the method according to any of the first aspect.

In a fourth aspect, the embodiments of the present application provide a computer-readable storage medium. The computer-readable storage medium comprises instructions, wherein the instructions instruct a device to implement the method according to any of the first aspect.

In a fifth aspect, the embodiments of the present application provide a computer program product. The computer program product, when executed on a computer, causes the computer to implement the method according to any of the first aspect.

Compared with the prior art, the embodiment of the present application has the following advantages:
the embodiments of the present application provide the method for presenting information, and the method may be executed on a client side, for example. In an instance, the user may trigger, on the client side, the relationship viewing operation on the entry carrier of the target keyword. The entry carrier mentioned herein may be a carrier configured to carry content of an entry, and the entry carrier of the target keyword may be configured to carry the content information of the target keyword. After the user triggers the relationship viewing operation, the entry association corresponding to the target keyword may be obtained on the client side in response to triggering the relationship viewing operation on the entry carrier of the target keyword by the user, where the entry association corresponding to the target keyword is configured to present the primary associated keyword associated to the target keyword and the secondary associated keyword associated to the target keyword, and the secondary associated keyword is a keyword associated to the primary associated keyword. After obtaining the entry association corresponding to the target keyword, the client side may further present the entry association of the target keyword. Since the entry association of the target keyword comprises the primary associated keyword associated to the target keyword and the secondary associated keyword associated to the target keyword, the entry association corresponding to the target keyword may provide the user with an association between the target keyword and other keywords, such that the user can determine a keyword associated to the target keyword, and demand of the user is better satisfied.

### BRIEF DESCRIPTION OF THE DRAWINGS

To describe technical solutions in the embodiments of the present application or in the prior art more clearly, accompanying drawings required in description of the embodiments or in the prior art will be described briefly below. Apparently, the accompanying drawings in the following description merely show some embodiments described in the present application, and a person of ordinary skill in the art can still derive other accompanying drawings from these accompanying drawings without creative efforts.

FIG. 1 is a schematic flowchart of a method for presenting information according to embodiments of the present application;

FIG. 2 is a schematic diagram of an entry viewing page according to embodiments of the present application;

FIG. 3 is a schematic diagram of an entry relationship graph according to embodiments of the present application;

FIG. 4 is another schematic diagram of an entry relationship graph according to embodiments of the present application;

FIG. 5 is yet another schematic diagram of an entry relationship graph according to embodiments of the present application; and

FIG. 6 is a schematic structural diagram of an apparatus for presenting information according to embodiments of the present application.

### DETAILED DESCRIPTION OF EMBODIMENTS

In order to enable those skilled in the art to better understand solutions of the present application, the technical solutions in embodiments of the present application will be described below clearly and comprehensively in conjunction with accompanying drawings of the embodiments of the present application. Apparently, the embodiments described are merely some embodiments rather than all embodiments of the present application. All other embodiments derived by a person of ordinary skill in the art from the embodiments of the present application without creative efforts fall within the protection scope of the present application.

Various nonrestrictive embodiments of the present application will be described in detail below in conjunction with the accompanying drawings.

### Illustrative Method

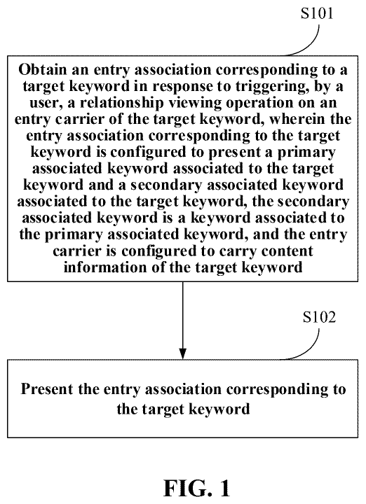

With reference to FIG. 1, a schematic flowchart of a method for presenting information is shown according to embodiments of the present application. The method for presenting information according to the embodiments of the present application may be implemented on a client side. In an instance, the client side may be a client side corresponding to an application program. In an instance, the application program may be an application program capable of providing various functions. For example, the application program may provide functions such as instant messaging, cloud documents, encyclopedia, etc. The encyclopedia may include entries for a plurality of keywords.

The method for presenting information according to the embodiments of the present application may include, for example, S101-S102.

S101: obtaining an entry association corresponding to a target keyword in response to triggering, by a user, a relationship viewing operation on an entry carrier of the target keyword, wherein the entry association corresponding to the target keyword is configured to present a primary associated keyword associated to the target keyword and a secondary associated keyword associated to the target keyword, the secondary associated keyword is a keyword associated to the primary associated keyword, and the entry carrier is configured to carry content information of the target keyword.

The entry carrier mentioned in the embodiments of the present application refer to a carrier for an entry. The entry carrier may be configured to carry content information included in the entry. That is, the entry carrier of the target keyword is configured to carry the content information of the target keyword. The entry carrier is not specifically limited in the embodiments of the present application. In an instance, the entry carrier may be an entry card. The entry card may be a page similar to a card displayed on the client side.

In the embodiments of the present application, the entry carrier of the target keyword may be displayed on the client side. In an instance, the entry carrier of the target keyword may be presented after the user triggers a preset operation on the target keyword. For example, the target keyword is displayed on a first page of the client side. After the user triggers the preset operation on the target keyword on the first page, the client side displays the entry carrier of the target keyword. The preset operation mentioned herein may be a click operation or a hover operation, and is not specifically limited in the embodiments of the present application.

In an instance, the client side may detect a target content displayed on the first page, and highlight the target keyword if the target keyword including the entry is detected in the target content. Thus, the user triggers the preset operation on the target keyword conveniently. The highlighting the target keyword indicates that a display mode of the target keyword is different from a display mode of other content in the first page. For example, the target keyword is displayed in bold, while the other content in the first page are not displayed in bold. For example, the target keyword comprises an underline, while the other content in the first page do not have underlines. The underline mentioned herein may be a solid line or a dotted line, and is not specifically limited in the embodiments of the present application.

In the embodiments of the present application, the first page may be an instant messaging session page or a cloud document page. When the first page is the instant messaging session page, the target content may be a message of an instant messaging session. When the first page is the cloud document page, the target content may be a content of a cloud document.

In further instance, the entry carrier of the target keyword may be presented on the entry viewing page. As an instance, the entry viewing page may be a page provided by an encyclopedia function. As an instance, the user may trigger an operation of viewing the entry page by using an entry viewing function provided by the encyclopedia function. Accordingly, the client side may display the entry viewing page in response to the operation of viewing the entry page triggered by the user. The entry viewing page is not specifically limited in the embodiments of the present application. For example, the entry viewing page may be configured to view entry carriers of keywords of various types.

In some embodiments, the entry viewing page may include entry carriers of a plurality of keywords. One entry carrier displays a part of content corresponding to the entry. With the entry carrier of the target keyword as an example, the entry carrier of the target keyword in the entry viewing page is presented in a first area of the entry viewing page, and a part of the content of the target keyword are displayed in the first area. In this case, in an instance, the user may also trigger an entry viewing operation on the entry carrier of the target keyword, so as to view complete content of the target keyword. In order to improve user experience, in the embodiments of the present application, after the user triggers the entry viewing operation on the entry carrier of the target keyword, the client side may display complete content carried on the entry carrier in a second area in response to the entry viewing operation. The second area is obtained by expanding the first area, and the second area comprises the first area. For example, the first area is a rectangular area, and the second area is another rectangular area obtained by vertically expanding the rectangular area. Since the second area is obtained by expanding the first area, the user may view the complete content of the target keyword displayed in the second area without much visual jump, such that the user experience is better.

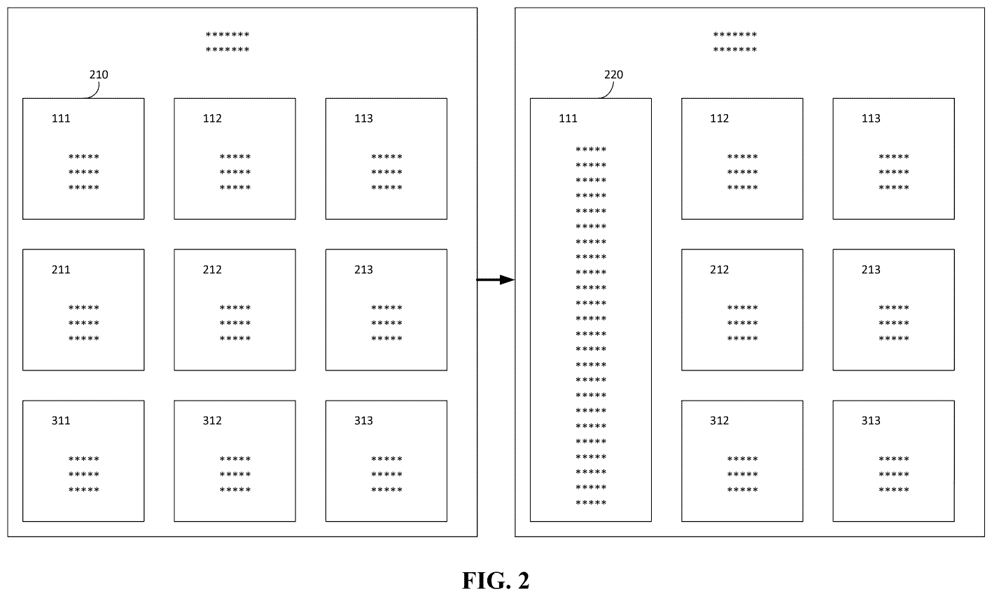

Understanding may be done with reference to FIG. 2. FIG. 2 is a schematic diagram of an entry viewing page according to embodiments of the present application.

The entry viewing page shown at a left side of FIG. 2 comprises entry carriers of nine keywords, that is, an entry carrier corresponding to a keyword 111, an entry carrier corresponding to a keyword 112, an entry carrier corresponding to a keyword 113, an entry carrier corresponding to a keyword 211, an entry carrier corresponding to a keyword 212, an entry carrier corresponding to a keyword 213, an entry carrier corresponding to a keyword 311, an entry carrier corresponding to a keyword 312 and an entry carrier corresponding to a keyword 313. When the user triggers the entry viewing operation on the keyword 111 as the target keyword, the content displayed on the entry viewing page changes to a style shown at a right side of FIG. 2 (that is, the entry carrier of the keyword 111 switches from a folded state to an unfolded state). In this page, a display area corresponding to the entry carrier of the target keyword is expanded from an area 210 shown at a left side to an area 220 shown at a right side. In an unfolded style, the area of the entry carrier of the keyword 111 is expanded, such that more content are displayed. In addition, content originally presented in the folded state in the area 210 are still presented in the area 220 in the unfolded style in the same presentation positions. Thus, when the keyword 111 is switched from the folded state to the unfolded state, visual consistency of the user is stronger.

In another instance, the entry carrier of the target keyword may be presented on an entry search result page. As an instance, the foregoing encyclopedia function may provide an entry search function. The user may trigger an entry search operation by using the entry search function provided by the encyclopedia function. Accordingly, the client side may display a corresponding entry search result page in response to the entry search operation triggered by the user.

In an instance, the entry search result page may include entry carriers corresponding to the plurality of keywords. In this case, in order to make an entry search result provided satisfies demand of the user as much as possible, in the embodiments of the present application, the entry carriers displayed in the entry search result page may be entry carriers of associated entries. As an instance, the entry carriers corresponding to the plurality of keywords included in the entry search result page may include the entry carrier corresponding to the target keyword and the entry carrier of the primary associated keyword associated to the target keyword.

In the embodiments of the present application, the user may trigger the relationship viewing operation on the entry carrier of the target keyword, so as to obtain more information associated to the target keyword. In an instance, the entry carrier of the target keyword may include a control for triggering the relationship viewing operation, and the user may trigger the foregoing relationship viewing operation by clicking on the control. In an instance, an icon for identifying the control may be displayed on the entry carrier of the target keyword, and the user may trigger the foregoing relationship viewing operation by clicking on an area where the icon is located. The icon is not specifically displayed in the embodiments of the present application. The icon may be, for example, an arrow or an icon of the entry association (for example, the entry relationship graph mentioned below), which will not be enumerated herein.

After the user triggers the relationship viewing operation on the entry carrier of the target keyword, the client side may obtain the entry association corresponding to the target keyword in response to the relationship viewing operation. The entry association corresponding to the target keyword is configured to present the primary associated keyword associated to the target keyword and the secondary associated keyword associated to the target keyword.

The primary associated keyword associated to the target keyword refers to a keyword that has a direct association with the target keyword. The secondary associated keyword associated to the target keyword refers to a keyword that has an indirect association with the target keyword. In an instance, the secondary associated keyword and the target keyword may establish an association through the primary associated keyword. That is, the secondary associated keyword is a keyword associated to the primary associated keyword. The secondary associated keyword may be considered as a primary associated keyword of the primary associated keyword.

In an instance, the entry association corresponding to the target keyword may be used to present M primary associated keywords associated to the target keyword and N secondary associated keywords associated to the target keyword. M and N are integers greater than or equal to 1.

The entry relationship graph is not specifically limited in the embodiments of the present application. In an instance, the entry association may be an entry relationship table. In a further instance, with consideration of that the graph is more intuitive in expressing the association, the entry association may also be the entry relationship graph.

S102: presenting the entry association corresponding to the target keyword.

After obtaining the entry association corresponding to the target keyword, the client side may present the entry association corresponding to the target keyword. Thus, according to the scheme of the embodiments of the present application, although the information provided by the entry carrier of the target keyword may not satisfy demand of the user, the user may view the entry association corresponding to the target keyword by triggering the relationship viewing operation on the entry carrier, so as to obtain more information. Thus, by using this scheme, more information associated to the target keyword can be provided for the user, thus satisfying the demand of the user.

In a scenario where the entry of the target keyword is provided by the encyclopedia function, the user experience of the encyclopedia function can be improved by using the scheme of the embodiments of the present application. Specifically, the encyclopedia function may provide the entry of the target keyword, and the entry carrier provided by the encyclopedia function may further support triggering of the relationship viewing operation. After the user triggers the relationship viewing operation on the entry carrier of the target keyword, the entry association corresponding to the target keyword may be presented to the user, thus providing the user with more information associated to the target keyword.

In an instance, when the entry association corresponding to the target keyword is the entry relationship graph, in order to provide a better visual effect for the user, the foregoing M primary associated keywords may be distributed evenly on a circle with the target keyword as a center when S102 is specifically implemented.

In an instance, for the M primary associated keywords, there may be an association between a second primary associated keyword and a third secondary associated keyword. In this case, in order to make an association in the entry relationship graph clearer, in an instance, a distance between the second primary associated keyword and the third primary associated keyword is shorter than or equal to a distance between the second primary associated keyword and other primary associated keywords. The other primary associated keywords are primary associated keywords among the M primary associated keywords other than the second primary associated keyword and the third primary associated keyword. In other words, in an instance, the second primary associated keyword and the third primary associated keyword may be two adjacent keywords on the circle with the target keyword as the center.

In an instance, an association between the secondary primary associated keyword and a third secondary associated keyword may also be shown in the entry relationship graph. For example, a connection line between the second primary associated keyword and the third secondary associated keyword is included to indicate the association.

In a further instance, for the M primary associated keywords, a fourth primary associated keyword and a fifth primary associated keyword may both have associations with a first secondary associated keyword among the N secondary associated keywords. In this case, in order to make the association in the entry relationship graph clearer, in an instance, a distance between the fourth primary associated keyword and the fifth primary associated keyword is shorter than or equal to a distance between the fourth primary associated keyword and other primary associated keywords. The other primary associated keywords are primary associated keyword among the M primary associated keywords other than the fourth primary associated keyword and the fifth primary associated keyword. In other words, in an instance, the fourth primary associated keyword and the fifth primary associated keyword may be two adjacent keywords on the circle with the target keyword as the center. In this way, an association between the fourth primary associated keyword and the first secondary associated keyword is clearer, and a relationship between the fifth primary associated keyword and the first secondary associated keyword is clearer.

As mentioned above, the secondary associated keyword associated to the target keyword refers to a keyword associated to the primary associated keyword associated to the target keyword. For the convenience of description, any of the M primary associated keywords is referred to as the “first primary associated keyword”, and the secondary associated keyword associated to the target keyword may include A secondary associated keywords associated to the first primary associated keyword. In this case, when presented, the A secondary associated keywords may be distributed on a circle with the first primary associated keyword as a center.

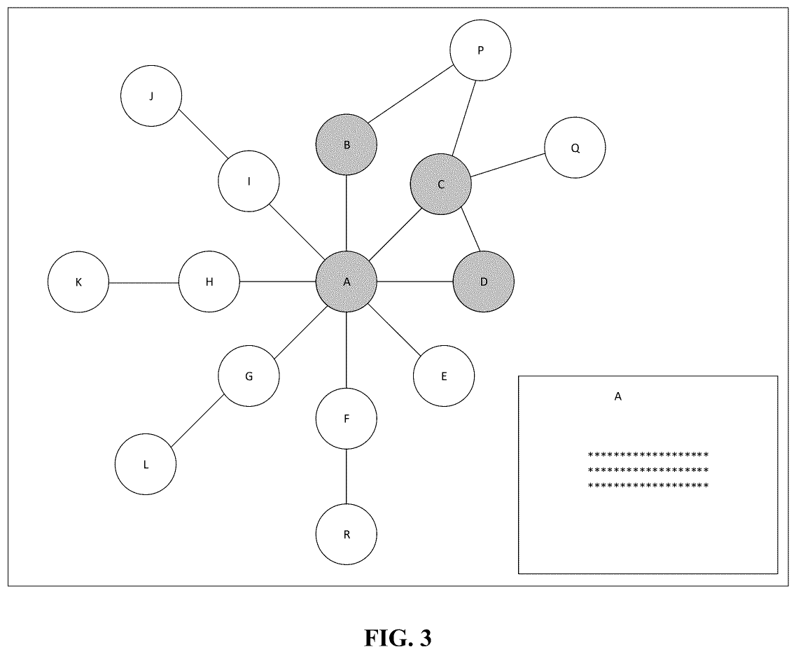

The entry relationship graph will be described below with reference to FIG. 3. FIG. 3 is a schematic diagram of an entry relationship graph according to embodiments of the present application.

In the entry relationship graph shown in FIG. 3:

The target keyword is denoted by A, and the target keyword comprises eight primary associated keywords, that is, a keyword B, a keyword C, a keyword D, a keyword E, a keyword F, a keyword G, a keyword H and a keyword I.

The target keywords include six secondary associated keywords, that is, a keyword J associated to the primary associated keyword I, a keyword K associated to the primary associated keyword H, a keyword L associated to the primary associated keyword G, a keyword R associated to the primary associated keyword F, a keyword Q associated to the primary associated keyword C, and a keyword P associated to both the primary associated keyword B and the primary associated keyword C.

The eight primary associated keywords are distributed evenly on a circle with the target keyword A as a center. In addition, since the primary associated keyword C and the primary associated keyword D are associated, the primary associated keyword C and the primary associated keyword D are two adjacent keywords on the circle with the target keyword A as the center. Since both the primary associated keyword B and the primary associated keyword C are associated to the secondary associated keyword P, the primary associated keyword B and the primary associated keyword C are two adjacent keywords on the circle with the target keyword A as the center.

In addition, the keyword Q and the keyword P that are associated to the primary associated keyword C are distributed on a circle with the primary associated keyword C as a center.

In addition, an entry carrier of the keyword A is displayed in a lower right corner of a page where the keyword A is located.

After the client side shows the entry relationship graph of the target keyword, if the user wants to know a content associated to the first keyword in the entry relationship graph, the user may trigger a selection operation on the first keyword. Correspondingly, the client side may show the entry carrier corresponding to the first keyword in response to the selection operation on the first keyword triggered by the user. The entry carrier corresponding to the first keyword may be configured to carry content information of the first keyword. In this way, the user can obtain the content information of the first keyword through the entry carrier of the first keyword.

In the embodiments of the present application, the client side may display the entry carrier of the first keyword in a specific area of a page where the first keyword is located. The specific area may be, for example, a specific area in the page where the first keyword is located (for example, a lower left corner or a lower right corner), and the specific area may also be determined according to a position of the first keyword in the page. For example, the specific area may be an area near the first keyword.

The foregoing selection operation is not specifically limited in the embodiments of the present application. In an instance, the selection operation may be a click operation, that is, a user may trigger the selection operation on the first keyword by clicking on the first keyword. In a further instance, the selection operation may be a hover operation, that is, the user may trigger the selection operation on the first keyword by moving a cursor to an area where the first keyword is located.

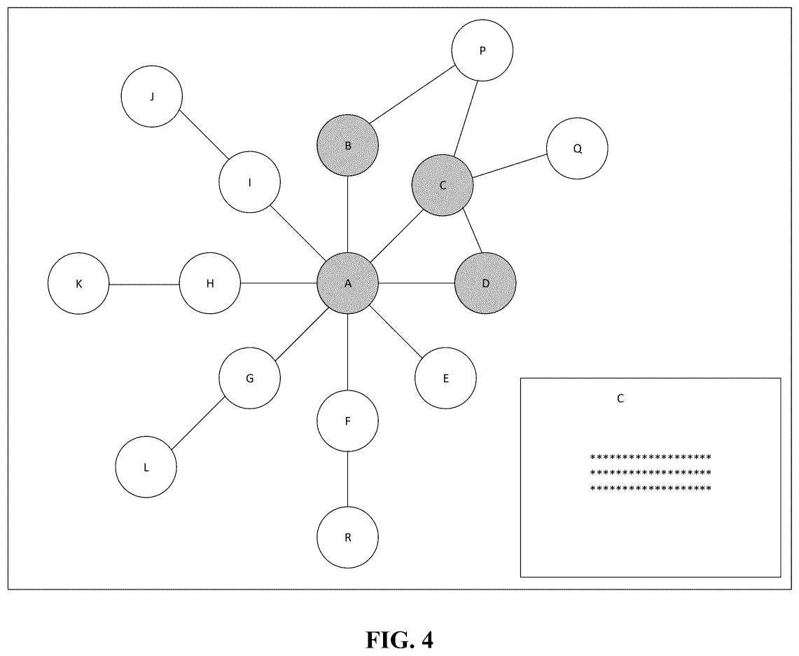

Understanding may be done with reference to FIG. 4. FIG. 4 is a schematic diagram of an entry relationship graph according to embodiments of the present application. In a scenario shown in FIG. 4, after the user triggers the selection operation on the keyword C, an entry carrier of the keyword C is displayed in a lower right corner of the page.

In an instance, with consideration of that information provided by the entry carrier of the first keyword is limited, the client side may also display an entry relationship graph corresponding to the first keyword in order to provide the user with more information associated to the first keyword. The entry relationship graph corresponding to the first keyword may be used to present a primary associated keyword associated to the first keyword and a secondary associated keyword associated to the first keyword.

Reference can be made to the related descriptions of the primary associated keyword associated to the target keyword and the secondary associated keyword associated to the target keyword for the primary associated keyword associated to the first keyword and the secondary associated keyword associated to the first keyword, which will not be described in detail herein.

The layout of the primary associated keyword and the secondary associated keyword that correspond to the first keyword in the entry relationship graph corresponding to the first keyword is the same as the layout of the primary associated keyword and the secondary associated keyword that correspond to the target keyword in the entry relationship graph corresponding to the target keyword. Reference can be made to the description of the entry relationship graph corresponding to the target keyword for related content, which will not be repeated herein.

In an instance, the client side may keep a position of the first keyword in the page unchanged when displaying the entry relationship graph corresponding to the first keyword. In other words, it is assumed that the first keyword is located in a first position in the page when the client side presents the entry relationship graph of the target keyword, then the first keyword is still located in the first position in the page when the client side presents the entry relationship graph corresponding to the first keyword. In this way, when the user is viewing the entry relationship graph of the first keyword, there will not be much visual jump, and the user experience is better.

In a further instance, with consideration of that the user triggers the selection operation on the first keyword, it means that the user wants to know more content about the first keyword. By arranging a content focused by the user in a center of the page, the user can view the content focused more conveniently. Accordingly, by arranging the content focused by the user in the center of the page, the user experience can be further enhanced. In view of this, in this case, the content focused by the user may be presented in the center of the page in the embodiments of the present application. In this case, the client side may also adjust the presentation of the first keyword to a center of the page where the first keyword is located. In other words, the first keyword is located in the center of the page when the entry relationship graph corresponding to the first keyword is presented.

In the embodiments of the present application, the first keyword may be the primary associated keyword of the target keyword or the secondary associated keyword of the target keyword. Thus, the entry relationship graph of the first keyword and the entry relationship graph of the target keyword have partially identical relationships and different relationships. In an instance, when the first keyword is the primary associated keyword of the target keyword, the target keyword is also a primary associated keyword of the first keyword, and other primary associated keywords among the primary associated keywords of the target keyword except the first keyword are secondary associated keywords of the first keyword. That is, both the entry relationship graph of the first keyword and the entry relationship graph of the target keyword include a previous association between the foregoing target keyword and the primary associated keyword of the target keyword. In addition, the entry relationship graph of the first keyword does not include keywords associated to other primary associated keywords among the primary associated keywords of the target keyword other than the first keyword. Description will be made with reference to FIG. 3:

It is assumed that the first keyword is the keyword C, the entry relationship graph corresponding to the keyword C does not include an association between the keyword I and the keyword J, an association between the keyword H and the keyword K, an association between the keyword G and the keyword L, and an association between the keyword F and the keyword R shown in FIG. 3. Specifically:

The keyword C comprises four primary associated keywords, that is, a keyword A, a keyword D, a keyword P and a keyword Q.

The keyword C comprises several secondary associated keywords, that is, a keyword B, a keyword E, a keyword F, a keyword G, a keyword H and a keyword I associated to the primary associated keyword A. In addition, although not shown in FIG. 3, the keyword C may further include a secondary associated keyword associated to the keyword D, a secondary associated keyword associated to the keyword P, and a secondary associated keyword associated to the keyword Q.

The user triggers the selection operation on the first keyword, indicating that the user wants to know more content associated to the first keyword. In this case, in order to avoid interference caused by too many content displayed on the page to the user, the different associations in the entry relationship graph corresponding to the target keyword and the entry relationship graph corresponding to the first keyword are not presented when the entry relationship graph corresponding to the first keyword is presented.

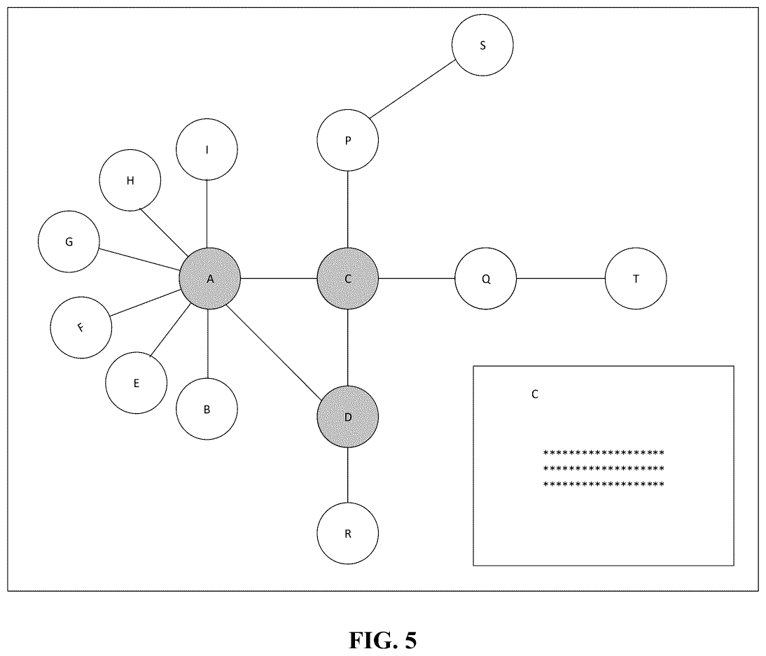

Understanding may be done with reference to FIG. 5. FIG. 5 is a further schematic diagram of an entry relationship graph according to embodiments of the present application. After the user triggers the selection operation on the keyword C in the entry relationship graph as shown in FIG. 3, in an instance, the client side may display the entry relationship graph as shown in FIG. 5.

In the entry relationship graph as shown in FIG. 5:

The keyword C comprises four primary associated keywords, that is, a keyword A, a keyword D, a keyword P and a keyword Q.

The keyword C comprises nine secondary associated keywords, that is, a keyword B, a keyword E, a keyword F, a keyword G, a keyword H and a keyword I that are associated to the primary associated keyword A, a keyword R associated to the primary associated keyword D, a keyword S associated to the primary associated keyword P, and a keyword T associated to the primary associated keyword Q.

The four primary associated keywords are distributed evenly on a circle with the keyword C as a center. In addition, since the primary associated keyword A and the primary associated keyword D are associated, the primary associated keyword A and the primary associated keyword D are two adjacent keywords on the circle with the keyword C as the center.

In addition, the keyword B, the keyword E, the keyword F, the keyword G, the keyword H, and the keyword I that are associated to the primary associated keyword A are distributed on a circle with the primary associated keyword A as the center.

In addition, an entry carrier of the keyword C is displayed in a lower right corner of a page where the keyword C is located.

With regard to FIGS. 2, 3, 4 and 5 described above, it should be noted that they are merely shown for the convenience of understanding the scheme of the embodiments of the present application, and do not constitute the limitation to the embodiment of the present application. For example, although the entry carrier of keyword A is located in the lower right corner of the page in FIG. 3, the entry carrier of keyword A may also be located in other areas of the page. For example, although the keyword C is located in the center of the page in FIG. 5, the position of the keyword C in the page may also be as shown in FIG. 3 in practice, that is, a presentation position of the keyword C in the page is kept unchanged when the entry relationship graph of the keyword C is presented. For example, a number of primary associated keywords of the keyword A is not limited to eight as shown in FIG. 3, which is not enumerated herein.

In an instance, the client side may also present an association between the target keyword and the primary associated keyword of the target keyword. In an instance, the association between the target keyword and the primary associated keyword of the target keyword may be embodied as the connection line between the target keyword and the primary associated keyword in the entry relationship graph corresponding to the target keyword. For example, in the entry relationship graph, the connection line between the target keyword and the keyword A indicates that there is an association between the target keyword and the keyword A.

In a further instance, the association between the target keyword and the primary associated keyword may be embodied as relationship attribute description information between the target keyword and the primary associated keyword. Based on the relationship attribute description information, the user may determine a specific association between the target keyword and the primary associated keyword.

In a specific instance, the association between the target keyword and the primary associated keyword may include a connection line and the relationship attribute description information between the target keyword and the primary associated keyword. For example, the relationship attribute description information may be presented in a presentation area (for example, a middle part of the connection) where the connection line between the target keyword and the primary associated keyword is located. For example, if the primary associated keyword B is a product name associated to the target keyword, the relationship attribute description information “related product” may be presented on the connection line between the primary associated keyword B and the target keyword.

In an instance, the client side may also present an association between the secondary associated keyword of the target keyword and the primary associated keyword of the target keyword. In an instance, the association between the secondary associated keyword and the primary associated keyword may be embodied as a connection line between the secondary associated keyword and the primary associated keyword in the entry relationship graph corresponding to the target keyword. For example, in the entry relationship graph, the connection line between the secondary associated keyword C and the primary associated keyword D indicates that there is an association between the secondary associated keyword C and the primary associated keyword D.

In a further instance, the association between the secondary associated keyword and the primary associated keyword may be embodied as relationship attribute description information between the secondary associated keyword and the primary associated keyword. Based on the relationship attribute description information, the user may determine a specific association between the secondary associated keyword and the primary associated keyword.

In a specific instance, the association between the secondary associated keyword and the primary associated keyword may include a connection line and the relationship attribute description information between the secondary associated keyword and the primary associated keyword. For example, the relationship attribute description information may be presented in a presentation area where the connection line between the secondary associated keyword and the primary associated keyword is located. For example, if the secondary associated keyword C is a concept associated to the primary associated keyword D, the relationship attribute description information “related concept” may be presented on the connection line between the secondary associated keyword C and the primary associated keyword D.

In an instance, the entry relationship graph may include a second keyword. The second keyword may be any keyword presented in a current entry relationship graph interface. For example, the second keyword may be the target keyword, or the second keyword may be the primary associated keyword of the target keyword, or the second keyword may also be the secondary associated keyword of the target keyword, which is not specifically limited in the embodiments of the present application. In an instance, the second keyword may be associated to a character. In this case, when the entry association corresponding to the target keyword is presented, the character associated to the second keyword may be presented. The character mentioned in the embodiments of the present application may be a user or a character in a work such as a book or a film and television work, which is not specifically limited in the embodiments of the present application.

In an instance, when the character associated to the second keyword is presented, a character identification of the character associated to the second keyword may be presented. The character identification mentioned in the embodiments of the present application may be, for example, a name of the character, or an image of the character, which is not specifically limited in the embodiments of the present application. In a specific instance, the character identification may be presented as an attribute of the second keyword in the entry relationship graph. In this case,

optionally or additionally, the character and the entry having an association with the character may be stored in association. Thus, when a trigger operation on the character identification presented in the entry relationship graph is received, at least one entry associated to the character may be presented.

In an instance, the user may also trigger an operation on the second keyword, for example, trigger a click operation on the second keyword. Correspondingly, the client side may display at least one entry associated to the second keyword in response to the trigger operation on the second keyword. Thus, the user obtains more information associated to the second keyword conveniently through the at least one entry associated to the second keyword.

In one possible implementation, an entry adding operation may be performed on the entry relationship graph. For example, the user may trigger the entry adding operation on the entry relationship graph. Correspondingly, the client side may add an entry into the entry relationship graph in response to the entry adding operation triggered on the entry relationship graph. For example, the user may trigger the entry adding operation on the target keyword, thereby adding a primary associated keyword to the target keyword. For example, the user may trigger the entry adding operation on the primary associated keyword of the target keyword, thereby adding the secondary associated keyword to the target keyword. In this way, the scheme allows the user to add an entry in the entry relationship graph, making the entry relationship graph more complete. It should be noted that when the entry is added into the entry relationship graph, an existing entry may be associated to one or several keywords presented in a current entry relationship graph, or entry establishment may be triggered in the entry relationship graph at first, and then the entry is associated to one or several keywords shown in a current entry relationship graph.

In an instance, the entry relationship graph may include a third keyword. The third keyword may be any keyword presented on a current entry relationship graph interface. For example, the third keyword may be the target keyword, or the third keyword may be the primary associated keyword of the target keyword, or the third keyword may also be the secondary associated keyword of the target keyword, which is not specifically limited in the embodiments of the present application. In an instance, the user may trigger an editing operation on the third keyword and edit description information for the third keyword. Correspondingly, the client side may obtain the description information edited for the third keyword and add the description information for the third keyword in response to the editing operation triggered on the third keyword. In this way, the scheme allows the user to trigger an editing operation on the keyword in the entry relationship graph, making the description information of the keyword more abundant.

In an instance, the entry relationship graph interface may include a search input area. The user may input a search keyword and further trigger a search operation on the search keyword in the search input area. Correspondingly, the client side may present an entry relationship graph corresponding to the search keyword in response to the search operation triggered on the search keyword. When the search keyword is the target keyword, the client side may obtain the entry association corresponding to the target keyword in response to the search operation triggered on the target keyword, and further present the entry relationship graph corresponding to the target keyword based on the entry association corresponding to the target keyword. In this case, the “relationship viewing operation triggered by the user on the entry carrier of the target keyword” mentioned above may be the search operation triggered by the user on the target keyword on the entry relationship graph interface.

### Illustrative Apparatus

Based on the method provided in the example described above, the embodiments of the present application further provide an apparatus. The apparatus will be described with reference to the accompanying drawings.

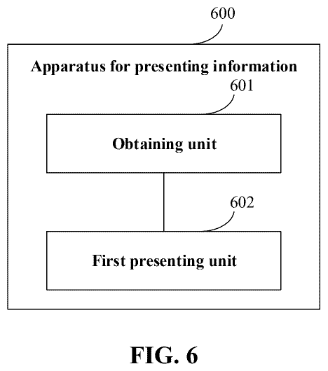

With reference to FIG. 6, a schematic structural diagram of an apparatus for presenting information is shown according to embodiments of the present application. The apparatus 600 may specifically comprises, for example, an obtaining unit 601 and a first presenting unit 602.

The obtaining unit 601 is configured to obtain an entry association corresponding to a target keyword in response to triggering, by a user, a relationship viewing operation on an entry carrier of the target keyword, wherein the entry association corresponding to the target keyword is configured to present a primary associated keyword associated to the target keyword and a secondary associated keyword associated to the target keyword, the secondary associated keyword is a keyword associated to the primary associated keyword, and the entry carrier is configured to carry content information of the target keyword.

The first presenting unit 602 is configured to present the entry association corresponding to the target keyword.

Optionally, the entry carrier of the target keyword is presented in response to triggering, by the user, a preset operation on the target keyword.

Optionally, the apparatus further comprises:
a display unit, configured to highlight the target keyword in response to detecting the target keyword in target content.

Optionally, the target content comprises: a message of an instant messaging session, and/or content of a cloud document.

Optionally, the entry carrier of the target keyword is presented on an entry viewing page.

Optionally, the entry carrier of the target keyword is presented in a first area of the entry viewing page, and the apparatus further comprises:
a second presenting unit, configured to present, in a second area, complete content carried by the entry carrier in response to triggering, by the user, an entry viewing operation on the entry carrier of the target keyword, wherein the second area is obtained by expanding the first area, and the second area comprises the first area.

Optionally, the entry carrier of the target keyword is presented on an entry search result page.

Optionally, the entry search result page further comprises an entry carrier of the primary associated keyword associated to the target keyword.

Optionally, the entry association is an entry relationship graph.

Optionally, the apparatus further comprises:
a third presenting unit, configured to present an entry carrier corresponding to a first keyword presented in the entry relationship graph in response to triggering, by the user, a selection operation on the first keyword.

Optionally, the selection operation comprises a click operation and/or a hover operation.

Optionally, the apparatus further comprises:
a fourth presenting unit, configured to present an entry relationship graph corresponding to the first keyword, wherein the entry relationship graph corresponding to the first keyword is configured to present a primary associated keyword associated to the first keyword and a secondary associated keyword associated to the first keyword.

Optionally, the apparatus further comprises:
a fifth presenting unit, configured to adjust a presentation of the first keyword to a center of a page where the first keyword is located.

Optionally, the first keyword is presented at a first position in a page where the first keyword is located, and the first position is a position where the first keyword is located in a case that the page presents the entry relationship graph of the target keyword.

Optionally, in a case that the entry relationship graph corresponding to the first keyword is presented, a different association between the entry relationship graph corresponding to the target keyword and the entry relationship graph corresponding to the first keyword is not presented.

Optionally, a number of primary associated keywords associated to the target keyword presented in the entry relationship graph of the target keyword is M, M is an integer greater than 1, and the M primary associated keywords are distributed evenly on a circle with the target keyword as a center.

Optionally, a number of primary associated keywords associated to the target keyword presented in the entry relationship graph of the target keyword is M, M is an integer greater than 1, the M primary associated keywords comprise a first primary associated keyword, the secondary associated keyword associated to the target keyword comprises A secondary associated keywords associated to the first primary associated keyword, and the A secondary associated keywords are distributed on a circle with the first primary associated keyword as a center.

Optionally, a number of primary associated keywords associated to the target keyword presented in the entry relationship graph of the target keyword is M, M is an integer greater than 1, and the M primary associated keywords comprise a second primary associated keyword and a third primary associated keyword, wherein in a case that the second primary associated keyword and the third primary associated keyword are associated, a distance between the second primary associated keyword and the third primary associated keyword is shorter than or equal to a distance between the second primary associated keyword and a further primary associated keyword, and wherein the further primary associated keyword is a primary associated keyword among the M primary associated keywords other than the second primary associated keyword and the third primary associated keyword.

Optionally, a number of primary associated keywords associated to the target keyword presented in the entry relationship graph of the target keyword is M, a number of secondary associated keywords associated to the target keyword presented in the entry relationship graph of the target keyword is N, M and N are integers greater than 1, the N secondary associated keywords comprise a first secondary associated keyword, and the M primary associated keywords comprise a fourth primary associated keyword and a fifth primary associated keyword, wherein in a case that the fourth primary associated keyword and the fifth primary associated keyword are associated to the first secondary associated keyword, a distance between the fourth primary associated keyword and the fifth primary associated keyword is shorter than or equal to a distance between the fourth primary associated keyword and a further primary associated keyword, and wherein the further primary associated keyword is a primary associated keyword among the M primary associated keywords other than the fourth primary associated keyword and the fifth primary associated keyword.

Optionally, the apparatus further comprises:
a sixth presenting unit configured to present an association between the target keyword and the primary associated keyword; and
presenting unit configured to present an association between the primary associated keyword and the secondary associated keyword.

Optionally, the sixth presenting unit is configured to:
present a connection line and/or relationship attribute description information between the target keyword and the primary associated keyword.

Optionally, the seventh presenting unit is configured to:
present a connection line and/or relationship attribute description information between the primary associated keyword and the secondary associated keyword.

Optionally, the entry relationship graph comprises a second keyword, and a character identifier of a character associated to the second keyword is presented as an attribute of the second keyword in the entry relationship graph, and the apparatus further comprises an eighth presenting unit and/or a ninth presenting unit.

The eighth presenting unit is configured to present at least one entry associated to the character in response to a trigger operation on the character identification; and
the ninth presenting unit is configured to present at least one entry associated to the second keyword in response to a trigger operation on the second keyword.

Optionally, the apparatus further comprises:
an entry adding unit, configured to add an entry into the entry relationship graph in response to triggering an entry adding operation on the entry relationship graph.

Optionally, the entry relationship graph comprises a third keyword, and the apparatus further comprises:
a processing unit, configured to obtain description information edited for the third keyword and adding the description information for the third keyword, in response to triggering an editing operation on the third keyword.

Optionally, the obtaining unit is configured to obtain an entry association corresponding to the target keyword in response to triggering, by the user, a search operation on the target keyword in an interface of the entry relationship graph.

As the apparatus 600 is an apparatus corresponding to the method according to the method example described above, specific implementation of units of the apparatus 600 is according to the same conception as that of the method example described above. Thus, reference can be made to the description of the method example described above for specific implementation of the units of the apparatus 600, which is not repeated herein.

In a third aspect, the embodiments of the present application provide a device. The device comprises a processor and a memory.

The processor is configured to execute instructions stored in the memory, causing the device to execute the method for presenting information according to any of the method example described above.

The embodiments of the present application provide a computer-readable storage medium. The computer-readable storage medium comprises instructions, where the instructions instruct a device to execute the method for presenting information according to any of the method example described above.

The embodiments of the present application provide a computer program product. The computer program product, when executed on a computer, causes the computer to implement the method for presenting information according to any of the method example described above.

Those skilled in the art could easily conceive of other implementation solutions of the present application after considering the description and implementing the invention disclosed herein. The present application is intended to cover any variation, use or adaptive change of the present application, which follows general principles of the present application and comprises common general knowledge or conventional technical means in the technical field not disclosed in the present application. The description and the example are merely considered illustrative, and a true scope and spirit of the present application are indicated by the following claims.

It should be understood that the present application is not limited to precise structures described above and shown in the accompanying drawings, and various modifications and changes can be made without departing from the scope of the present application. The scope of the present application is merely limited by the appended claims.

The embodiments described above are merely preferred embodiments of the present application but are not intended to limit the present application, and any modification, equivalent replacement, improvement, etc. made within the spirit and principles of the present application should fall within the protection scope of the present application.

1. A method for presenting information, comprising:
obtaining an entry association corresponding to a target keyword in response to triggering, by a user, a relationship viewing operation on an entry carrier of the target keyword, wherein the entry association corresponding to the target keyword is configured to present a primary associated keyword associated to the target keyword and a secondary associated keyword associated to the target keyword, the secondary associated keyword is a keyword associated to the primary associated keyword, and the entry carrier is configured to carry content information of the target keyword; and
presenting the entry association corresponding to the target keyword.

2. The method according to claim 1, wherein the entry carrier of the target keyword is presented in response to triggering, by the user, a preset operation on the target keyword.

3. The method according to claim 1, further comprising:
highlighting the target keyword in response to detecting the target keyword in target content.

4. The method according to claim 3, wherein the target content comprises at least one of the following: a message of an instant messaging session, or content of a cloud document.

5. The method according to claim 1, wherein the entry carrier of the target keyword is presented on an entry viewing page.

6. The method according to claim 5, wherein the entry carrier of the target keyword is presented in a first area of the entry viewing page, and the method further comprises:
presenting, in a second area, complete content carried by the entry carrier in response to triggering, by the user, an entry viewing operation on the entry carrier of the target keyword, wherein the second area is obtained by expanding the first area, and the second area comprises the first area.

7. The method according to claim 1, wherein the entry carrier of the target keyword is presented on an entry search result page.

8. The method according to claim 7, wherein the entry search result page further comprises an entry carrier of the primary associated keyword associated to the target keyword.

9. The method according to claim 1, wherein the entry association is an entry relationship graph.

10. The method according to claim 9, further comprising:
presenting an entry carrier corresponding to a first keyword presented in the entry relationship graph in response to triggering, by the user, a selection operation on the first keyword.

11. The method according to claim 10, wherein the selection operation comprises at least one of a click operation or a hover operation.

12. The method according to claim 10, further comprising:
presenting an entry relationship graph corresponding to the first keyword, wherein the entry relationship graph corresponding to the first keyword is configured to present a primary associated keyword associated to the first keyword and a secondary associated keyword associated to the first keyword.

13. The method according to claim 10,
wherein the method further comprises: displaying the first keyword at a central area of a page where the first keyword is located.

14. (canceled)

15. The method according to claim 12, wherein when the entry relationship graph corresponding to the first keyword is being presented, stop displaying the association in the entry relationship graph corresponding to the target keyword which is not corresponding to the entry relationship graph of the first keyword.

16. The method according to claim 9,
wherein a number of primary associated keywords associated to the target keyword presented in the entry relationship graph of the target keyword is M, M is an integer greater than 1, and the M primary associated keywords are distributed evenly on a circle with the target keyword as a center; or
wherein a number of primary associated keywords associated to the target keyword presented in the entry relationship graph of the target keyword is M, M is an integer greater than 1, the M primary associated keywords comprise a first primary associated keyword, the secondary associated keyword associated to the target keyword comprises A secondary associated keywords associated to the first primary associated keyword, and the A secondary associated keywords are distributed in a circle with the first primary associated keyword as a center; or
wherein a number of primary associated keywords associated to the target keyword presented in the entry relationship graph of the target keyword is M, M is an integer greater than 1, and the M primary associated keywords comprise a second primary associated keyword and a third primary associated keyword, wherein in a case that the second primary associated keyword and the third primary associated keyword are associated, a distance between the second primary associated keyword and the third primary associated keyword is shorter than or equal to a distance between the second primary associated keyword and a further primary associated keyword, and wherein the further primary associated keyword is a primary associated keyword among the M primary associated keywords other than the second primary associated keyword and the third primary associated keyword; or
wherein a number of primary associated keywords associated to the target keyword presented in the entry relationship graph of the target keyword is M, a number of secondary associated keywords associated to the target keyword presented in the entry relationship graph of the target keyword is N, M and N are integers greater than 1, the N secondary associated keywords comprise a first secondary associated keyword, and the M primary associated keywords comprise a fourth primary associated keyword and a fifth primary associated keyword, wherein in a case that the fourth primary associated keyword and the fifth primary associated keyword are associated to the first secondary associated keyword, a distance between the fourth primary associated keyword and the fifth primary associated keyword is shorter than or equal to a distance between the fourth primary associated keyword and a further primary associated keyword, and wherein the further primary associated keyword is a primary associated keyword among the M primary associated keywords other than the fourth primary associated keyword and the fifth primary associated keyword.

17-19. (canceled)

20. The method according to claim 1, further comprising:
presenting an association between the target keyword and the primary associated keyword; and
presenting an association between the primary associated keyword and the secondary associated keyword.

21. The method according to claim 20, wherein the association comprises at least one of:
a connection line representing the association, or relationship attribute description information representing the association.

22. The method according to claim 9,
wherein the entry relationship graph comprises a second keyword, and a character identification of a character associated to the second keyword is presented as an attribute of the second keyword in the entry relationship graph, and the method further comprises at least one of:
presenting at least one entry associated to the character in response to a trigger operation on the character identification; and
presenting at least one entry associated to the second keyword in response to a trigger operation on the second keyword, and/or
wherein the method further comprises: adding an entry into the entry relationship graph in response to triggering an entry adding operation on the entry relationship graph, and/or
wherein the entry relationship graph comprises a third keyword, and the method further comprises: obtaining description information edited for the third keyword and adding the description information for the third keyword, in response to triggering an editing operation on the third keyword, and/or
wherein in response to triggering, by the user, the relationship viewing operation on the entry carrier of the target keyword comprises: in response to triggering, by the user, a search operation on the target keyword in an interface of the entry relationship graph.

23-26. (canceled)

27. A device, comprising: a processor and a memory;
wherein the processor is configured to execute instructions stored in the memory, causing the device to:
obtain an entry association corresponding to a target keyword in response to triggering, by a user, a relationship viewing operation on an entry carrier of the target keyword, wherein the entry association corresponding to the target keyword is configured to present a primary associated keyword associated to the target keyword and a secondary associated keyword associated to the target keyword, the secondary associated keyword is a keyword associated to the primary associated keyword, and the entry carrier is configured to carry content information of the target keyword; and
present the entry association corresponding to the target keyword.

28. A non-transitory computer-readable storage medium, comprising instructions, wherein the instructions instruct a device to:
obtain an entry association corresponding to a target keyword in response to triggering, by a user, a relationship viewing operation on an entry carrier of the target keyword, wherein the entry association corresponding to the target keyword is configured to present a primary associated keyword associated to the target keyword and a secondary associated keyword associated to the target keyword, the secondary associated keyword is a keyword associated to the primary associated keyword, and the entry carrier is configured to carry content information of the target keyword; and
present the entry association corresponding to the target keyword.

29. (canceled)
